(19) United States
(12) Patent Application Publication
(10) Pub. No.: US 2006/0268781 A1
(43) Pub. Date: Nov. 30, 2006

(54) System and method for call handoff from packet data wireless network to circuit switched wireless network

(75) Inventors: Sven Anders Borje Svensson, San Diego, CA (US); Erik Colban, San Diego, CA (US); Martin Renschler, San Diego, CA (US); George Foti, Dollard Des Ormeaux (CA)

Correspondence Address: COATS & BENNETT, PLLC, P O BOX 5, RALEIGH, NC, 27602, US

(73) Assignee: Telefonaktiebolaget LM Ericsson (publ)

(21) Appl. No.: 11/268,123

(22) Filed: Nov. 7, 2005

Related U.S. Application Data
(60) Provisional application No. 60/676,790, filed on May 2, 2005.

(51) Int. Cl. H04Q 7/00

(52) U.S. Cl. 370/331; 370/352

(57) ABSTRACT

A Handoff (HO) Function facilitates the handoff of a hybrid AT/MT from a packet data wireless network to a circuit switched wireless network. The HO Function translates a handoff indication from the packet data network to an emulated circuit switched handoff request for the circuit switched network. The HO Function also passes handoff radio parameters from the circuit switched network to the packet data network. The handoff parameters are transmitted to the hybrid AT/MT, allowing it to tune to the frequency band of the circuit switched network. Additionally, the HO Function initiates the IMS network signaling necessary to route voice signals from the other party of the existing call, through the IMS network, and to the hybrid AT/MT on the circuit switched network. The HO Function controls a Media Gateway that translates call media between the packet data networks and the circuit switched network formats and protocols.

### RELATED APPLICATIONS

This application claims the benefit of U.S. Provisional Patent Application 60/676,790 filed May 2, 2005, which is incorporated herein by reference.

### BACKGROUND

The present invention relates generally to the field of wireless communication networks and in particular to a system and method for handing off a call from a packet data wireless network to a circuit switched wireless network.

Early wireless communication networks were circuit switched, with a communication channel dedicated to each call. A network “channel” may comprise a particular transmission frequency, a time slot in a Time Division Multiple Access (TDMA) system, a unique spreading code in a Code Division Multiple Access (CDMA) system, or the like. Circuit switched wireless networks are widely deployed and extensively used, communicating both voice and digital data to and from mobile users using mobile terminals (MT).

With the rapid growth of the Internet, technological advances in packet data networks have yielded network architectures, protocols, and equipment that route data in autonomous units (“packets”) using shared channels with high speed, low latency, and high network resource utilization efficiency. Recently, dedicated packet data wireless communication networks have been developed and deployed that route packetized voice (such as Voice over IP, or VoIP) and data packets to and from mobile users using mobile access terminals (AT). The distinguishing characteristic of such packet data wireless networks, as opposed to circuit switched wireless networks with packet data transmission capabilities, is that packet data for multiple users is transmitted over one or more shared, high bandwidth channels, rather than a dedicated channel being assigned to each user (or call). One example of such a dedicated packet data wireless communication network is the CDMA 1xEV-DO standard. The development, deployment, and use of packet data a wireless networks is expected to increase.

As with any cellular wireless network, mobility management is required to maintain communications with mobile MTs or ATs as users move throughout different geographic areas. Mobile Assisted Hand-Off (MAHO) is a well-known element of mobility management. In MAHO, mobile terminals report channel conditions, desired data rates, pilot strengths signals from neighboring radio base stations, and the like to a serving base station, which, using this information as well as the relative loading among neighboring base stations, determines if, when, and to which base station to hand off a mobile terminal.

One problem with some deployed packet data wireless networks (such as 1xEV-DO) is that the shared packet data channels are transmitted in a different frequency band than are the dedicated traffic channels in a corresponding circuit switched wireless network, and a mobile unit cannot operate on both frequencies at the same time. It may be possible to handoff a VoIP call on a packet data wireless network to, e.g., the packet data services available on a circuit switched wireless network if the proper service options were set in the standards to support the required Quality of Service (QoS) needed for the voice call, and if the networks support concurrent voice/data services. Because these conditions are not generally met by deployed wireless networks, a need exists in the art for a system and method to facilitate handoff of a VoIP call in a packet data wireless network to a conventional circuit switched wireless network for hybrid mobile units (AT/MT) that are capable of communications with both networks (e.g., in both frequency bands).

### SUMMARY

A Handoff (HO) Function facilitates the handoff of a hybrid Access Terminal/Mobile Terminal (AT/MT) from a packet data wireless network to a circuit switched wireless network. The HO Function receives a handoff indication from the packet data wireless network, and generates and forwards to the circuit switched wireless network (such as to an MSC) an emulated circuit switched handoff request. The HO Function receives handoff radio parameters from the circuit switched wireless network, encapsulates the handoff radio parameters into packets, and forwards them to the packet data wireless network. The handoff parameters are transmitted to the hybrid AT/MT, allowing the hybrid AT/MT to tune to the frequency band of the circuit switched wireless network.

Additionally, the HO Function initiates the IMS network signaling necessary to route voice signals from the other party of the existing call, through the IMS network, and to the hybrid AT/MT on the circuit switched wireless network. The HO Function additionally controls a Media Gateway that translates call media between the packet data networks and the circuit switched network formats and protocols.

In one embodiment, the present invention relates to a method of facilitating the handoff of a hybrid Access Terminal/Mobile Terminal (AT/MT), engaged in a call with another party, from a packet data wireless network to a circuit switched wireless network. A handoff indication is received from the packet data network. An emulated circuit switched handoff request is generated in response to the handoff indication. The emulated circuit switched handoff request is forwarded to the circuit switched network. Handoff radio parameters are received from the circuit switched network. The handoff radio parameters are encapsulated into data packets, and the handoff radio parameters are forwarded to the packet data network.

In another embodiment, the present invention relates to a Handoff (HO) Function with signaling connections to a packet data wireless network, a circuit switched wireless network, and at least one IP Multimedia Subsystem (IMS) network, and operative to facilitate the handoff of a hybrid Access Terminal/Mobile Terminal (AT/MT) from the packet data wireless network to the circuit switched wireless network. The HO Function includes a wireless network handoff translation module receiving a handoff indication from, and outputting packet-encapsulated handoff radio parameters to, the packet data wireless network, and outputting an emulated circuit switched handoff request to, and receiving handoff radio parameters from, the circuit switched wireless network. The HO Function additionally includes a IMS interface module exchanging SIP messages with a IMS network, and a Media Gateway Control Function (MGCF) controlling a Media Gateway (MGw).

In yet another embodiment, the present invention relates to a translation network operative to facilitate handoff of a hybrid Access Terminal/Mobile Terminal (AT/MT) from a packet data wireless network to a circuit switched wireless network. The translation network includes a Media Gateway (MGw) connected to the circuit switched wireless network via a dedicated handoff trunk and connected to one or more packet data networks by a packet data link, the MGw operative to translate media between packet data and circuit switched formats. The translation network also includes a Handoff (HO) Function controlling the MGw, the HO Function having signaling connections to the packet data wireless network, the circuit switched wireless network, and at least one IP Multimedia Subsystem (IMS) network.

In still another embodiment, the present invention relates to a method of facilitating the handoff of a hybrid Access Terminal/Mobile Terminal (AT/MT) from a packet data wireless network to a circuit switched wireless network by an Application Server (AS) having a sip:uri Public Service Identifier (PSI) in an IP Multimedia Subsystem (IMS) network, the PSI AS operative to handle inter-system handoffs and session transfer between IP connectivity points for a specific terminal. A SIP INVITE message directed to the PSI AS and indicating the hybrid AT/MT as the calling party is received. An ENUM conversion is performed on the hybrid AT/MT indicator to generate a SIP URI for the hybrid AT/MT. The called and calling party identifiers are swapped to generate a modified SIP INVITE message. The modified SIP INVITE message is sent to a Serving-Call Session Control Function (C-CSCF) in the IMS network.

### BRIEF DESCRIPTION OF DRAWINGS

FIG. 1 is a functional network diagram of an inter-packet data wireless network VoIP call between ATs.

FIG. 2 is a functional network diagram of the voice call of FIG. 1 following handoff from the packet data wireless network to a circuit switched wireless network.

FIG. 3 is a functional network diagram of a roaming packet data wireless network VoIP call between ATs.

FIG. 4 is a functional network diagram of the voice call of FIG. 3 following handoff from the packet data wireless network to a circuit switched wireless network.

FIG. 5 is a functional network diagram of a voice call between the PSTN and an AT in a packet data wireless network.

FIG. 6 is a functional network diagram of the voice call of FIG. 5 following handoff from the packet data wireless network to a circuit switched wireless network.

FIGS. 7A-7B constitute a call signal flow diagram.

FIGS. 8A-8E constitute a flow diagram describing the call flow diagram of FIGS. 7A-7B.

FIG. 9 is a functional block diagram of a Handoff Function network node.

### DETAILED DESCRIPTION

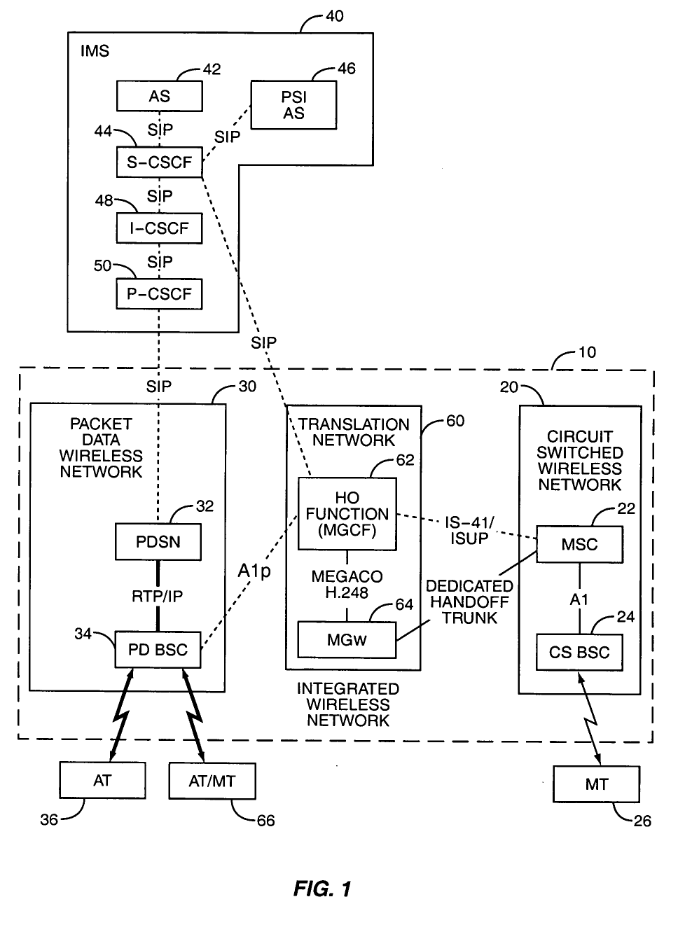

FIG. 1 depicts a representative wireless communication network 10, connected to an IP Multimedia Subsystem (IMS) network 40. The integrated wireless network 10 comprises a circuit switched wireless network 20, a packet data wireless network 30, and a translation network 60.

The circuit switched wireless network 20 comprises a Mobile Switching Center (MSC) 22, connected to one or more circuit switched Base Station Controllers (CS BSC) 24 providing communication services to one or more mobile terminals (MT) 26. The MSC 22 routes voice and data over circuit switched network connections between the CS BSC 24 and numerous other network nodes (not shown) such as for example the Public Switched Telephone Network (PSTN). The CS BSC 24 includes or controls one or more radio base stations or base station transceivers (not shown) that include the transceiver resources necessary to support radio communication with MTs 26, such as modulators/demodulators, baseband processors, radio frequency (RF) power amplifiers, antennas, and the like.

The packet data wireless network 30 comprises a Packet Data Switching Node (PDSN) 32 connected to one or more packet data Base Station Controllers (PD BSC) 34 providing packet data communication services to one or more access terminals (AT) 36. The PDSN 32 routes data packets between the PD BSC 34 and other packet data networks, such as the IMS 40. The PD BSC 34 includes or controls one or more radio base stations similar to the CS BSC 24, but provides packet data communications on shared, high-bandwidth channels to ATs 36, and, as depicted in FIG. 1, one or more hybrid AT/MTs operative to communicate with both the packet data wireless network 30 and the circuit switched wireless network 20.

The packet data wireless network 30 is connected to an IMS network 40. The IMS is a general-purpose, open industry standard for voice and multimedia communications over packet-based IP networks 40. The IMS network 40 includes one or more Application Servers (AS) providing various services (audio and video broadcast or streaming, push-to-talk, videoconferencing, games, filesharing, e-mail, and the like). In particular, a AS 42 maintains knowledge of all calls to and from the hybrid AT/MT 66. Another AS within the IMS 40 is a Public Service Identifier (PSI) AS 46. The PSI AS 46 is a generic AS that handles session transfer between IP connectivity points for a specific terminal. The PSI AS 46 handles inter-system handoffs within a system.

Communications between nodes within the IMS network 40 utilize the Session Initiation Protocol (SIP). SIP is a signaling protocol for Internet conferencing, telephony, presence, events notification, instant messaging, and the like. SIP uses a long-term stable identifier, the SIP Universal Resource Indicator (URI).

27 The AS 42 is connected to a Serving-Call Session Control Function (C-CSCF) 44. The C-CSCF 44 initiates, manages, and terminates multimedia sessions between IMS 40 terminals. In particular, the C-CSCF 44 is the registration server for the hybrid AT/MT 66. The C-CSCF 44 may be connected to an optional Interrogating-CSCF (I-CSCF) 48. The l-CSCF 48 is a SIP proxy located at the edge of an administrative domain. The I-CSCF (or C-CSCF if a l-CSCF is not present) is connected to a Proxy-CSCF (P-CSCF) 50. The P-CSCF is a SIP proxy that is the first point of contact to the IMS 40.

As depicted in FIG. 1, a AT 36 and a hybrid AT/MT 66 are connected through the packet data wireless network 30 in a VoIP voice call (that is, both users are on the same packet data wireless network 30). The call routing between the AT 36 and the hybrid AT/MT 66 is depicted by heavy solid lines. In particular, voice packets from the AT 36 are received by the PD BSC 34, routed through the PDSN 32, back to the PD BSC 34, and are transmitted to the hybrid AT/MT 66. Voice packets in the opposite direction follow the reverse route.

As the hybrid AT/MT 66 moves physically further from the radio transceiver resources of the PD BSC 34, the hybrid AT/MT 66 indicates poor channel conditions to the PD BSC 34, such as by requesting a lower data rate via a Data Rate Control (DRC) index. When the hybrid AT/MT 66 reports sufficiently poor channel conditions, the PD BSC 34 determines it must hand the hybrid AT/MT 66 off to another wireless network node.

If the packet data wireless network 30 is of limited geographic extent, and the hybrid AT/MT 66 is at the edge of its service area, it is likely that the hybrid AT/MT 66 may be served by a circuit switched wireless network 20, which are more widely deployed. However, the hybrid AT/MT 66 cannot simultaneously operate in the different frequency bands utilized by the packet data wireless network 30 and the circuit switched wireless network 20. CDMA soft handoff is thus impossible.

According to one or more embodiments of the present invention, the handoff of a hybrid AT/MT 66 from the packet data wireless network 30 to the circuit switched wireless network 20 is facilitated by a Handoff (HO) Function 62. The HO Function 62 is an inventive network node in the translation network 60 that resides between the packet data wireless network 30 and the circuit switched wireless network 20, as depicted in FIGS. 1-6. As will be readily apparent to those of skill in the art, the HO Function 62, as well as any other part of the translation network 60, may be logically considered a part of the packet data wireless network 30, the circuit switched wireless network 20, or the IMS network 40. Similarly, the circuits and/or software that implement the HO Function 62 functionality may physically reside within the PDSN 32, the MSC 22, or any other network node, as required or desired. Each PD BSC 34 has precisely one HO Function 62; however, a single HO Function 62 may serve as a plurality of PD BSCs 34.

When it determines that a handoff of the hybrid AT/MT 66 is necessary, the PD BSC 34 sends a handoff indication to the HO Function 62. The handoff indication is transmitted from the PD BSC 34 to the HO Function 62 over an Al p interface. The handoff indication includes a target MSC identifier and the International Mobile Subscriber Identity (IMSI) of the hybrid AT/MT 66 being handed off. Upon receipt of the handoff indication, the HO Function 62 generates an emulated circuit switched handoff request, and forwards the emulated circuit switched handoff request to the MSC 22. For example, the HO Function 62 may generate and send an IS-41 protocol FacilitiesDirective2 (FACDIR2) signal. The FACDIR2 includes a CircuitID perimeter indicating the dedicated trunk to which a Media Gateway 64 is connected (see below).

In one embodiment, the PD BSC 34 includes the ability to directly generate the emulated circuit switched handoff request (e.g., a FACDIR2 message) with the appropriate parameters, and encapsulate the HO Request in a packet data structure for transmission to the HO Function 62 as a handoff indication. In this embodiment, the HO Function 62 simply decapsulates the message and forwards it to the MSC 22. In another embodiment, the PD BSC 34 sends the HO Function 62 a handoff indication and the required parameters, and the HO Function 62 generates and forwards the emulated circuit switched handoff request.

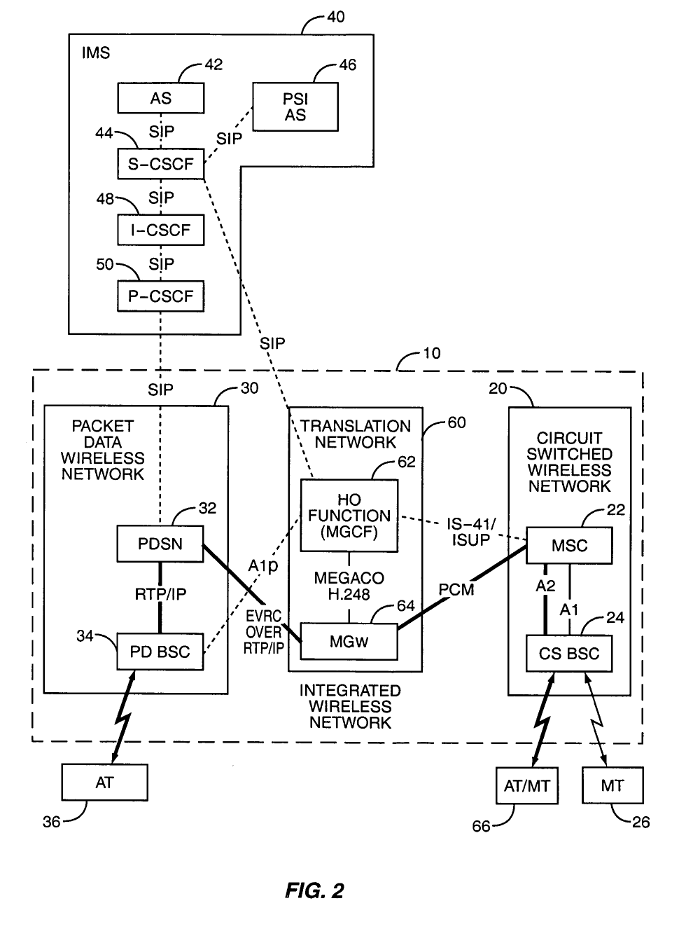

The MSC 22 receives the HO Request, and queries the CS BSC 24 to obtain handoff radio parameters. The CS BSC 24 allocates a channel for the handoff, and provides the handoff radio parameters associated with the allocated channel to the MSC 22. The MSC 22 returns the radio parameters to the HO Function 62. The HO Function 62 encapsulates the returned message containing the handoff radio parameters into a packet data structure, and forwards the parameters to the PD BSC 34 across the A1p interface. The PD BSC 34 transmits them to the hybrid AT/MT 66 to be handed off. The hybrid AT/MT 66 may then tune to the frequency band of the CS BSC 24, and begin communication with the circuit switched wireless network 20, as depicted in FIG. 2.

35 To route data from the packet data wireless network 30 to the MSC 22 and to translate between network protocols and data formats, the HO Function 62 selects a Media Gateway (MGw) 64 having a dedicated handoff trunk to the MSC 22. The HO Function 62, which includes a Media Gateway Control Function (MGCF), sets up the MGw 64 to translate the call between network protocols with a MEGACO or H.248 protocol Modify Request. The MGw 64 responds with a Modify Acknowledge, and activates the dedicated handoff trunk to the MSC 22. This sequence of transactions hands off the hybrid AT/MT 66 to the circuit switched wireless network 20, and provides for communications between the AT/MT 66 and the MGw 64.

To direct call data from the other party (in this case, the AT 36 on the packet data wireless network 30) to the MGw 64, the HO Function 62 sends a SIP INVITE message to the PSI AS 46, the IMS network 40 entity that handles handoff's for the system. The SIP INVITE message includes the IMSI of the hybrid AT/MT 66 in the P-Asserted ID header field of the SIP INVITE message. The P-Asserted ID header is functionally similar to the “From” header, but indicates that the address in the field has been validated. Upon receipt of the SIP INVITE message, the PSI AS 46 performs an ENUM conversion on the IMSI to convert it to a SIP URI, and swaps the contents of the “To” and P-Asserted ID header fields, i.e., the called and calling party identifiers. This swap transforms the SIP INVITE message into a call request from the PSI AS 46 to the SIP URI address of the hybrid AT/MT 66.

The PSI AS 46 sends the modified SIP INVITE message to the S-CSCF 44, which is the registration server for the hybrid AT/MT 66. Triggers in the S-CSCF 44 are set to include the AS 42 in the path for all calls terminating to the hybrid AT/MT 66. The modified SIP INVITE message is thus routed (via normal SIP routing procedures) to the AS 42. The AS 42 handles all calls for the hybrid AT/MT 66, and has knowledge of all existing calls. The AS 42 inspects the modified SIP INVITE message, detects the handoff (by recognizing the calling party), and establishes a dialogue between the AS 42 and the MGw 64. The AS 42 sends a SIP 200 OK signal to the S-CSCF 44, which is propagated back to the HO Function 62. The HO Function in turn sends a SIP ACK message back through the S-CSCF 44 to the AS 42, confirming the dialog establishment. The AS 42 then issues a SIP UPDATE message to the AS controlling call routing for the AT 36, to direct media (i.e., VoIP packets) transfer between the AT 36 and the MGw 64.

FIG. 2 depicts the networks after the handoff is complete. The heavy lines show the flow of the voice call: from the AT 36, through the PD BSC 34, and to the PDSN 32. Enhanced Variable Rate CODEC (EVRC) encoded voice packets are then transmitted via Real-time Transport Protocol (RTP) or Internet Protocol (IP) to the MGw 64. The MGW 64 translates the ERVC voice data to the 64 kbs Pulse Code Modulated (PCM) format of the circuit switched wireless network 20 backhaul, and transmits it to the MSC 22 over the dedicated handoff trunk. The MSC 22 sends the voice signals to the CS BSC 24 over an A2 interface, which transmits them to the hybrid AT/MT 66 on a dedicated channel. Voice signals in the opposite direction follow the reverse path.

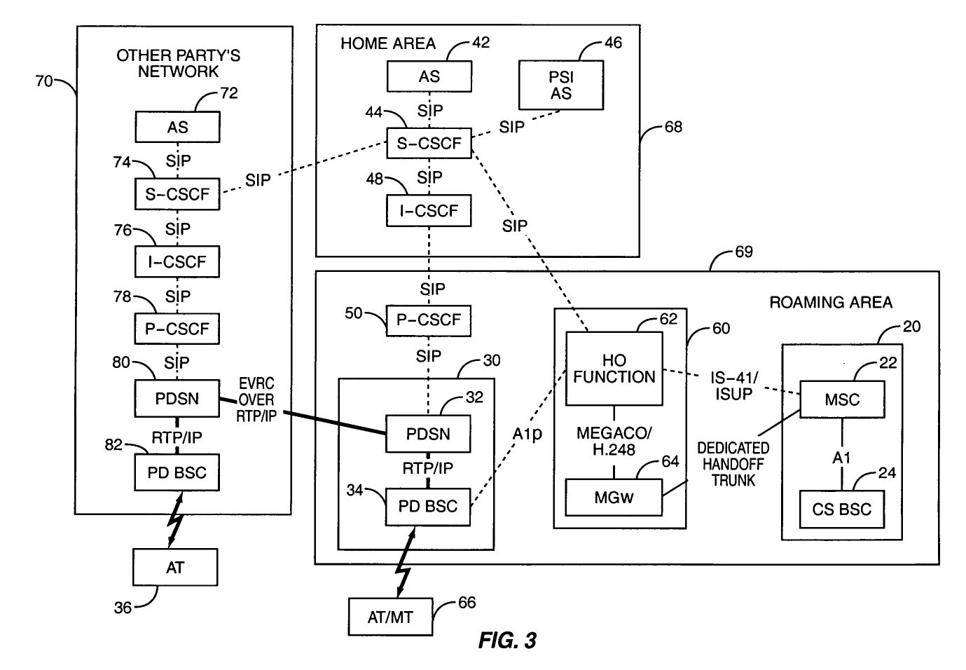

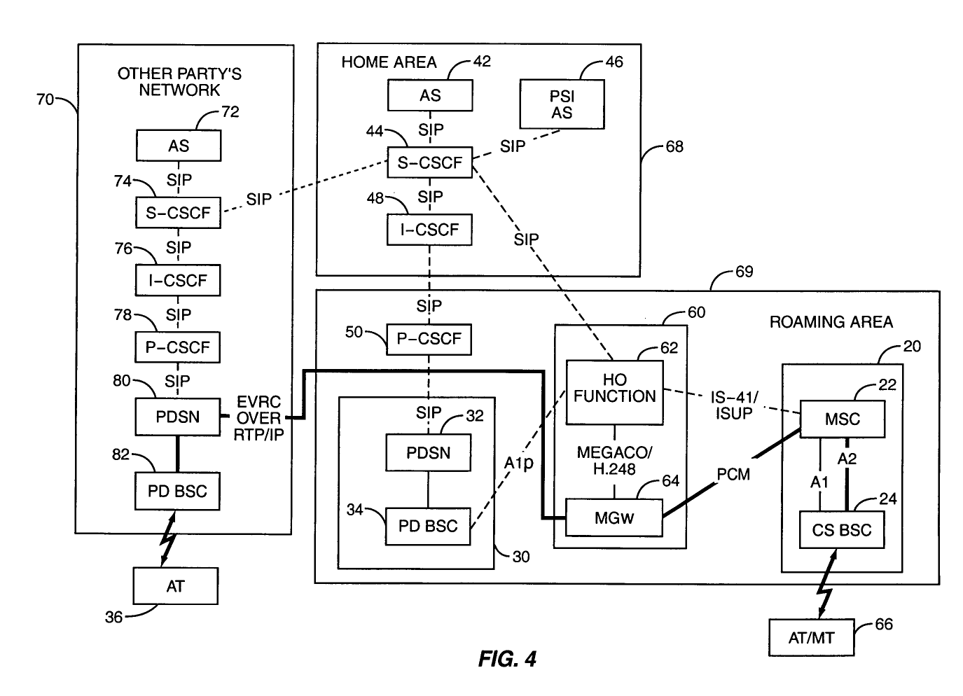

FIGS. 3 and 4 depict a similar handoff in the case of a roaming hybrid AT/MT 66. Referring to FIG. 3, the wireless network is divided into a home area 68 and a roaming area 69. The home area network includes at least the AS 42, S-CSCF 44, and PSI AS 46, and may optionally include a I-SCSF 48, as previously described. The roaming area network includes a circuit switched wireless network 20, a packet data wireless network 30, a transition network 60, and the Proxy-CSCF 50.

40 Another network 70, to which the other party of the VoIP call is connected, comprises a AS 72, a S-CSCF 74, an optional I-CSCF 76, a P-CSCF 78, a PDSN 80, and a PD BSC 82, with functionality as previously described. The flow of VoIP packets from the other party is indicated by heavy lines. Voice packets are routed from the AT 36 to the PD BSC 82, through the PDSN 80 and to the PDSN 32, as EVRC over an RTP or IP link. The voice packets are then routed to the PD BSC 34, and transmitted to the hybrid AT/MT 66. Voice packets in the opposite direction follow the reverse path.

As the user of the hybrid AT/MT 66 moves further from the radio transceivers of the PD BSC 34, the PD BSC 34 determines a handoff is required. If the user is moving to a geographic area served by the circuit switched wireless network 20 but not by another packet data wireless network, the PD BSC 34 may utilize the HO Function 62 to facilitate handing off the hybrid AT/MT 66 to the circuit switched wireless network 20.

42 Similarly to the non-roaming case describe above with reference to FIG. 1 and 2, the PD BSC 34 sends a handoff indication to the HO Function 62. The HO Function 62 generates (either itself or by decapsulating the handoff indication) and forwards an emulated handoff request to the MSC 22, receives handoff radio parameters from the MSC 22, encapsulates them in data packets, and forwards them to the PD BSC 34, which transmits the handoff radio parameters to the hybrid AT/MT 66, allowing it to tune to the frequency of the circuit switched wireless network 20.

The HO Function 62 also generates a SIP INVITE message “To” the PSI AS 46 and “From” (P-asserted ID) the hybrid AT/MT 66 and forwards the SIP INVITE message to the home area network 68. The INVITE is routed to the PSI AS 46, which swaps the called and calling party identifiers and forwards the message to the S-CSCF 44, which routes it to the AS 42 that controls calls for the hybrid AT/MT 66. The AS 42 detects the handoff, and sets up a dialog between the AS 42 and the MGw 64. The AS 42 additionally sends a SIP UPDATE message to the AS 72 that controls calls for the other party, directing its data stream to the MGw 64.

FIG. 4 depicts the networks following a successful handoff, with the call routing depicted by heavy lines. Voice packets are transmitted from the AT 36 to the PD BSC 82. The packets are then routed through the PDSN 80, which sends packetized EVRC data over an RTP or IP link to the MGw 64. The MGw 64 converts the voice signals from EVRC packets to PCM, and forwards them to the MSC 22 over a dedicated trunk. The MSC 22 forwards the voice signals to the CS BSC 24 over an A2 interface, and the CS BSC 24 transmits them to the hybrid AT/MT 66 over a dedicated channel. Voices signals in the opposite direction follow the reverse path.

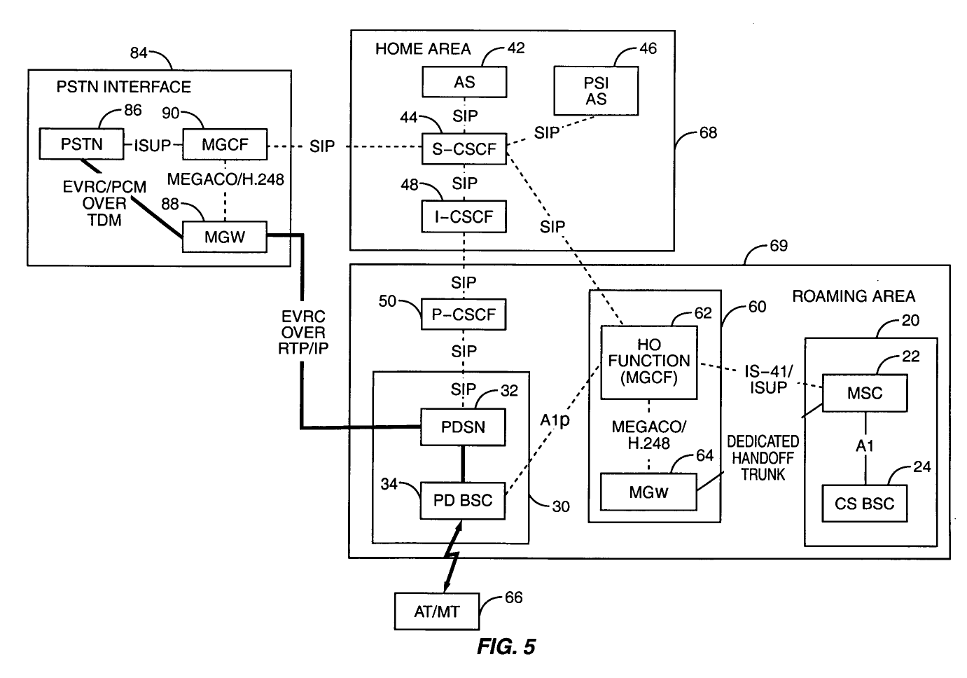

FIG. 5 depicts a roaming AT/MT 66 in a VoIP call with a party on the Public Switched Telephone Network (PSTN). A PSTN interface network 84 includes a Media Gateway Control Function (MGCF) 90 controlling a Media Gateway (MGw) 88 that is connected to the PSTN 86 over a time division multiplexed (TDM) link. The MGw 88 converts voice signals from EVRC or PCM on TDM to EVRC data packets and transmits them over an RTP or IP link to the PDSN 32. The PDSN 32 sends the voice data packets to the PD BSC 34, which transmits them to the hybrid AT/MT 66. VoIP packets in the opposite direction follow the reverse path.

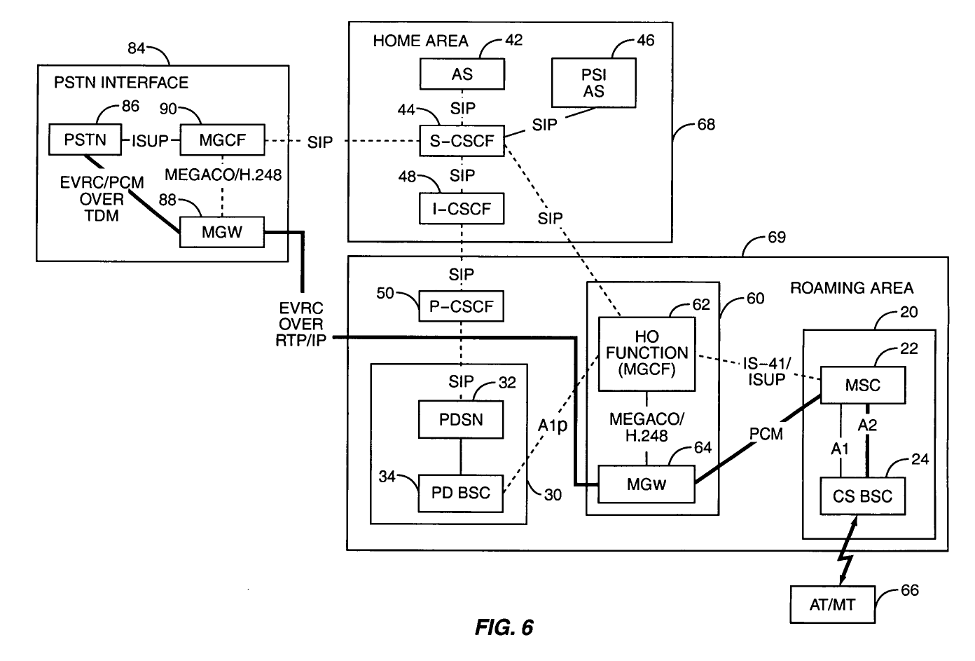

FIG. 6 depicts the call of the FIG. 5 following a handoff of the hybrid AT/MT 66 from the packet data wireless network 30 to the circuit switched wireless network 20, after network signaling as described above. As depicted by heavy lines, voice signals travel from a telephone in the PSTN 86 and are translated by the MGw 88 to EVRC data packets. The packet data is forwarded to the MGw 64, which translates it to PCM and sends it to the MSC 22 over a dedicated trunk. The MSC 22 forwards the voice signals over an A2 link to the CS BSC 24, which transmits them to the hybrid AT/MT 66 over a dedicated channel. Voice signals in the opposite direction follow the reverse path. The HO Function 62 facilitated the handoff by providing an interface between the PD BSC 34 and the MSC 22, as described above. The HO Function 62 additionally generated the SIP network signaling necessary to effectuate the handoff in the home area network 68, and to route call data from the other party.

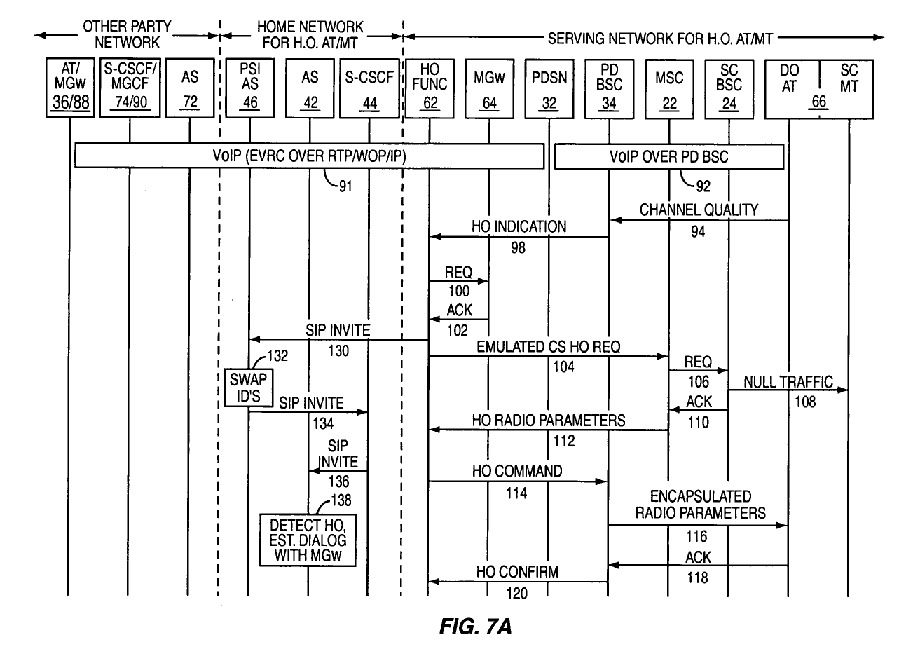

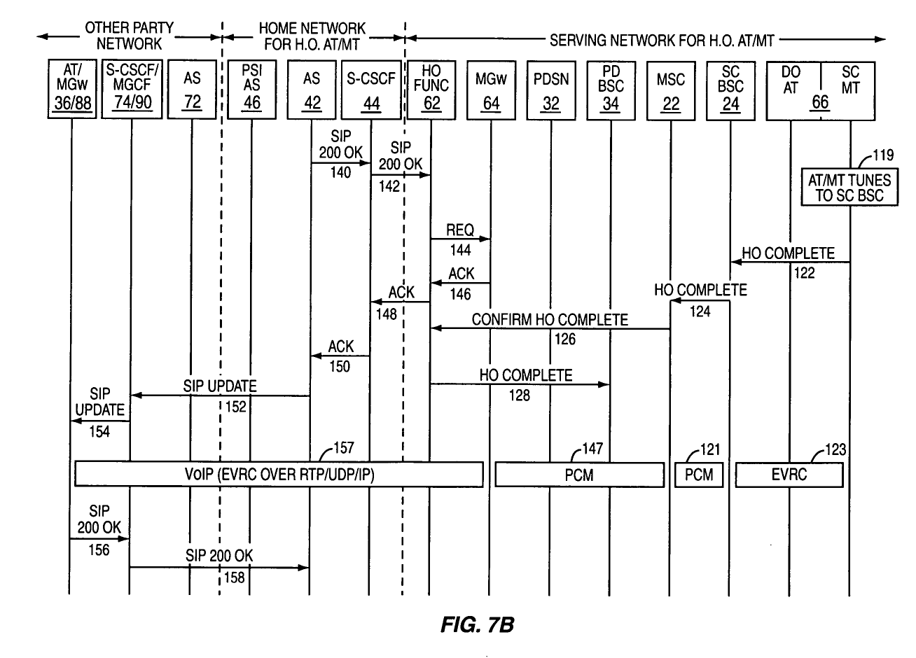

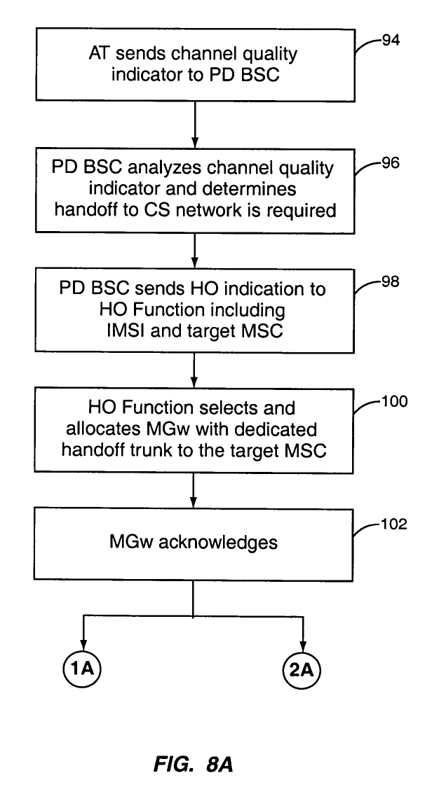

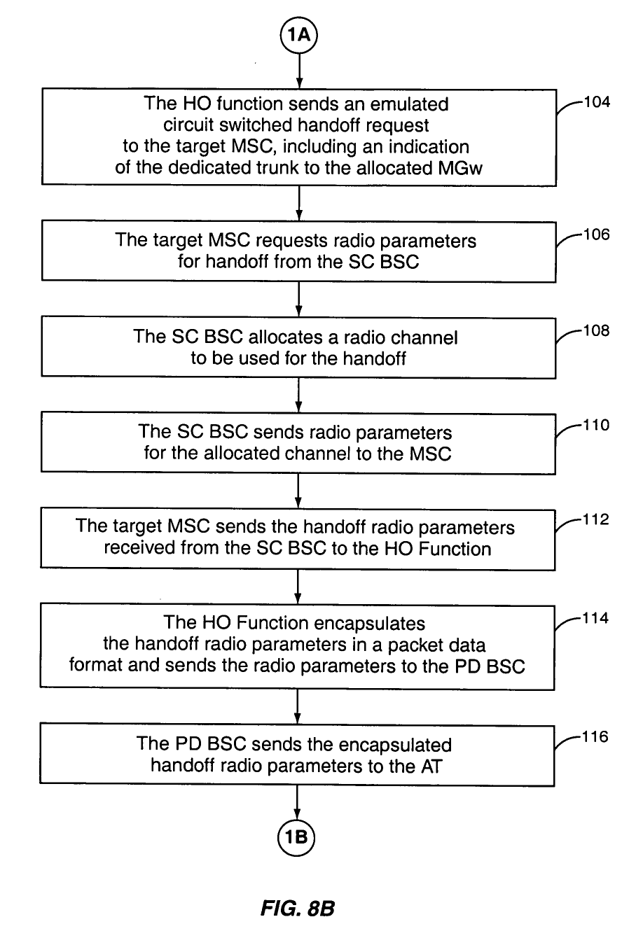

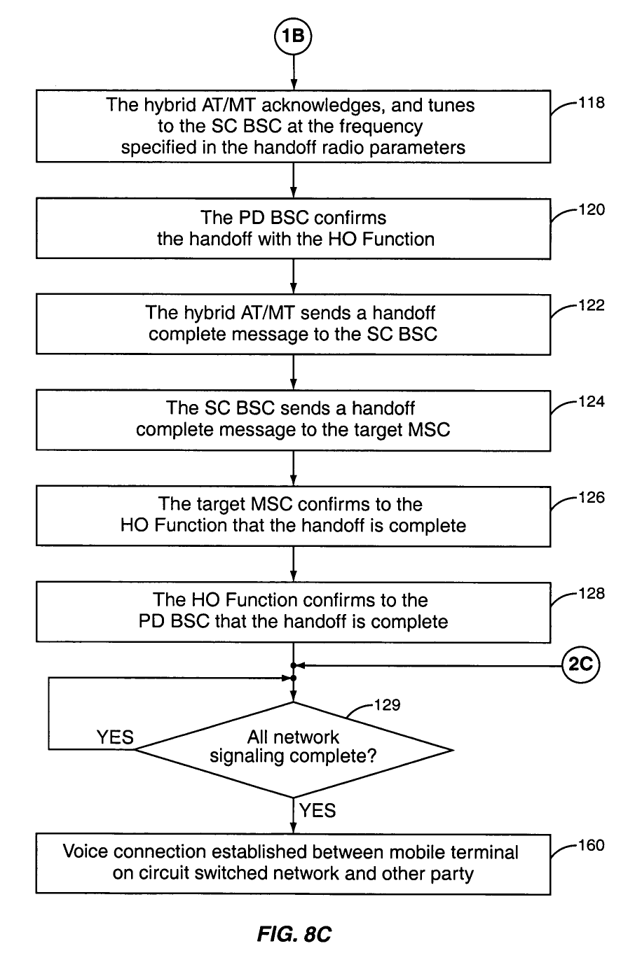

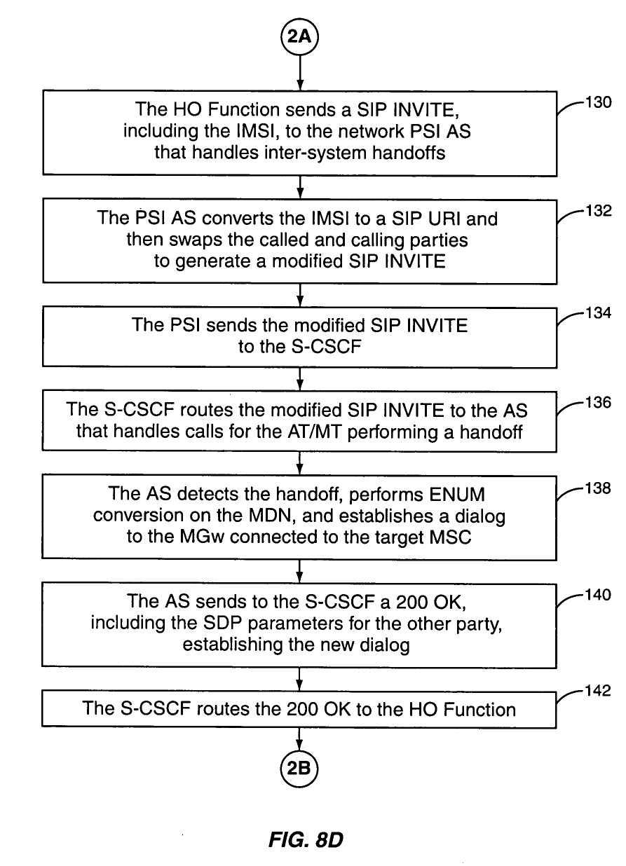

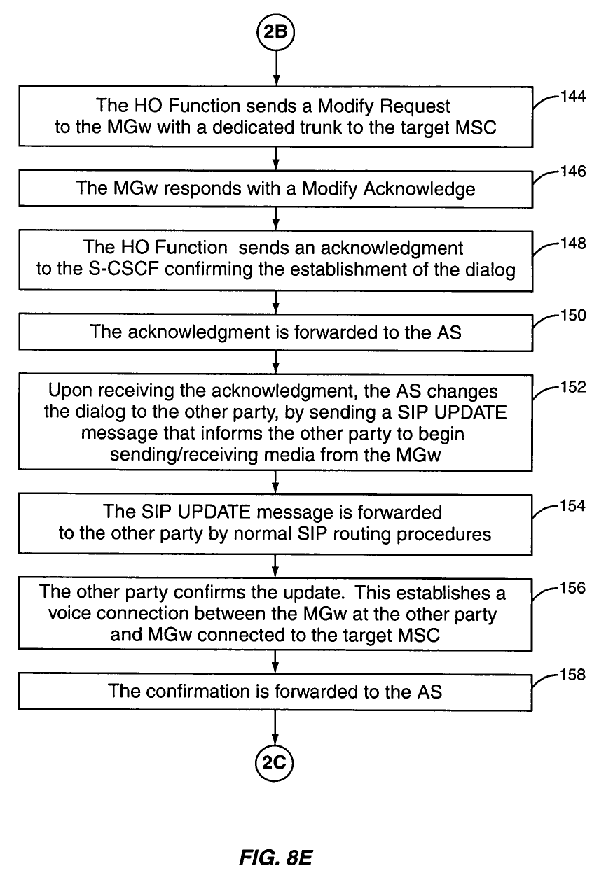

FIGS. 7A-7B depict the call flow of a handoff of a hybrid AT/MT 66 from a packet data wireless network 30 to a circuit switched wireless network 20, with the call flow entries described in flow diagram form in FIGS. 8A-8E. The reference numbers associated with call flows in FIGS. 7A-7B correspond with the blocks of the flow diagrams of FIGS. 8A-8E. The call flow diagram represents a general case, such as depicted in FIGS. 3-4 or 5-6.

Initially, a VoIP call exists between an AT 36 or MGw 88 (connecting to the PSTN 86) and the PDSN 32, as indicated in the call diagram of FIG. 7A at 91. The voice packets are communicated between the PDSN 32 and the hybrid AT/MT 66 via the PD BSC 34, as indicated at 92.

Referring to FIGS. 7A and 8A, the hybrid AT/MT 66 sends a channel quality indicator to the PD BSC 32 (block 94). The PD BSC 34 analyzes the channel quality indicator and determines a handoff to the circuit switched wireless network 20 is required (block 96). The PD BSC 34 sends a handoff indication to the HO Function 62, including the IMSI and target-MSCID (block 98). The HO Function 62 selects and allocates a MGw 64 with a dedicated handoff trunk to the target MSC 22 (block 100). The HO Function 62 includes a MGCF, and controls the MGw 64 via MEGACO/H.248 commands. The MGw 64 acknowledges (block 102).

At this point, the network activity may be logically divided into two parallel flows, as indicated in the flow diagram of FIG. 8A as flows 1 and 2. Flow 1 facilitates the handoff of the hybrid AT/MT 66 from the PD BSC 34 to the SC BSC 24. Flow 2 directs SIP commands into the IMS network 40 to set up the dialogues necessary to direct media (VoIP packets) between the other party and the MGw 64.

Considering flow 1 first (beginning with FIG. 8B), the HO Function 64 sends an emulated circuit switched handoff request to the MSC 22 (block 104). The emulated circuit switched handoff request may for example comprise an IS-41 FACDIR2 signal. The request includes an indication of the dedicated trunk to the allocated MGw 64, such as in a CircuitID parameter. The HO Request may be generated by the HO Function 62 in response to the handoff indication received from the PD BSC 34. Alternatively, the handoff indication may comprise an encapsulated emulated circuit switched handoff request that the PD BSC 34 generated; in this case, the HO Function 62 simply decapsulates the HO Request and forwards it to the MSC 22.

The MSC 22 queries the SC BSC 24 for handoff radio parameters (block 106). The SC BSC 24 allocates a channel for the hybrid AT/MT 66 (block 108). The SC BSC 24 sends the handoff radio parameters to the MSC 22 (block 110). The MSC 22 sends the handoff radio parameters received from the SC BSC 24 to the HO Function 62 (block 112).

The HO Function 62 encapsulates the radio handoff parameters in a packet data format and a sends the radio parameters and a handoff command to the PD BSC 34 (block 114). The PD BSC 34 sends the encapsulated handoff radio parameters to the hybrid AT/MT 66 (block 116). The hybrid AT/MT 66 acknowledges receipt of the radio handoff parameters (block 118), and proceeds to tune to the SC BSC 24 frequency (as indicated at 119 in the call flow diagram of FIG. 7B). The PD BSC 34 confirms the handoff to the HO Function 62 (block 120, FIG. 7A).

The hybrid AT/MT 66 sends a handoff complete message to the SC BSC 24 after turning to the appropriate frequency (block 122). The SC BSC 24 sends a handoff complete message to the MSC 22 (block 124). This establishes a (dormant) link comprising PCM over A2 between the MSC 22 and the SC BSC 24, as indicated in the call flow diagram of FIG. 7B at 121, and from the SC BSC 24 to the hybrid AT/MT 66 over the air interface, as indicated at 123. The MSC 22 confirms to the HO Function 62 that the handoff of the hybrid AT/MT 66 is complete (block 126). The HO Function 62 then confirms to the PD BSC 34 that the handoff is complete (block 128). This completes the signaling between the packet data wireless network 30 and the circuit switched wireless network 20, facilitated by the HO Function 62, necessary to effect handoff of the hybrid AT/MT 66 from the PD BSC 34 to the SC BSC 24. However, the handoff is not complete until the IMS network 40 signaling (e.g., flow 2) completes, as indicated in FIG. 8C by block 129.

Considering flow 2 in FIG. 8D (and with reference to the call flow diagram of FIG. 7A-7B), the HO Function 62 sends a SIP INVITE message to the PSI AS 46, which handles inter-system handoffs (block 130). The SIP INVITE message includes the IMSI of the AT/MT 66 in the P-asserted ID header. The PSI AS 46 performs an ENUM conversion on the IMSI to generate a SIP URI identifying the hybrid AT/MT 66, and then swaps the contents of the “To” and P-asserted ID (e.g., verified “From”) header fields (block 132). The PSI AS 46 sends the modified SIP INVITE message (which is now a request from the PSI AS 46 to the hybrid AT/MT 66) to the S-CSCF 44 (block 134).

The S-CSCF 44, which is the registration server for the hybrid AT/MT 66, includes triggers that include the AS 42 in the path for all calls terminating to the hybrid AT/MT 66. Accordingly, the S-CSCF 44 forwards the modified SIP INVITE message to the AS 42 (block 136). The AS 42, seeing a call from the PSI AS 46 to the hybrid AT/MT 66, detects the handoff, performs an ENUM conversion on the MDN, and establishes a dialog between the AS 42 and the MGw 64 (block 138). The AS 42 then sends a SIP 200 OK to the S-CSCF 44 including the Session Description Protocol (SDP) parameters for the other party, thus establishing the dialog (block 140). The S-CSCF 44 forwards the SIP 200 OK message to the HO Function 62 (block 142).

The HO Function 62 sends a Modify Request to the MGw 64 having a dedicated trunk to the MSC 22 (block 144). The MGw 64 response with a Modified Acknowledge (block 146). This activates a PCM data link over the dedicated trunk between the MGw 64 and the MSC 22, as indicated in the call flow diagram of FIG. 7B at 147. The HO Function 62 sends an SIP ACK to the S-CSCF 44 confirming the establishment of the dialog (block 148), and the ACK is forwarded to the AS 42 (block 150).

Upon receiving the acknowledgment, the AS 42 modifies the existing dialog with the other party, by sending a SIP UPDATE to the network entity controlling the other party (e.g., the S-CSCF 72 and AS 72 of FIGS. 3-4 or the MGCF 90 of FIGS. 5-6)(block 152). The SIP UPDATE is forwarded to the other party by normal SIP routing procedures (block 154). The other party confirms the update with a SIP 200 OK (block 156), establishing a VoIP connection between the other party and the MGw 64, as indicated in the call flow diagram of FIG. 7B at 157. The SIP 200 OK is forwarded to the AS 42 (block 158).

When both flows 1 and 2 of FIG. 8 have completed, as indicated at block 129 of FIG. 8C, a voice connection is established between the hybrid AT/MT 66 on the circuit switched wireless network 20 and the other party (block 160), and the handoff is complete. Referring to the call flow diagram of FIG. 7B, the media “pipe” for the post-handoff call comprises VoIP between the AT 36 or MGw 88 of the other party and the MGw 64 (157); PCM between the MGw 64 and the MSC 22 (149); PCM between the MSC 22 and SC BSC 24 (121); and EVRC over the air interface between the SC BSC 24 and the hybrid AT/MT 66 (123).

Inventive network elements of the present invention include the HO Function 62 as described above; in one embodiment a modified PD BSC 34 operative to create and packet-encapsulate a circuit switched handoff request; a hybrid AT/MT 66 with the ability to handle sending and receiving circuit switched handoff messages on the packet data bearer; and a PSI AS 46 function of swapping calling and called party identifiers in a SIP INVITE message, as well as the methods of network operation described herein.

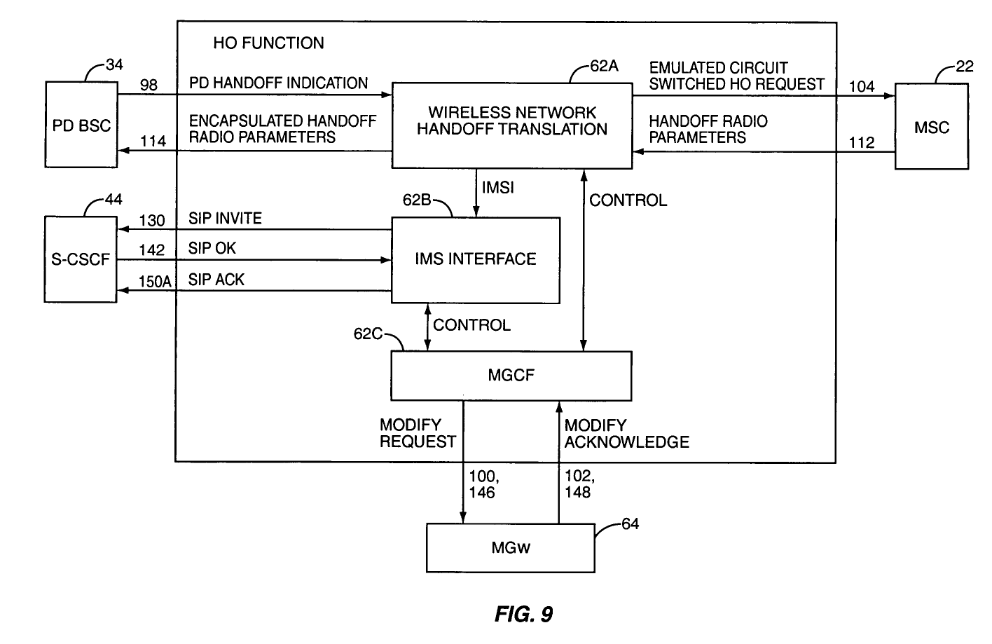

A functional block diagram of one embodiment of the HO Function 62 is depicted in FIG. 9. The HO Function 62 comprises a wireless network handoff translation module 62A, a IMS interface module 62B, and a Media Gateway Control Function (MGCF) 62C.

The wireless network handoff translation module 62A is connected, on the packet data side, to the PD BSC 34. On the circuit switched side, the wireless network handoff translation module 62A is connected to the MSC 22. The wireless network handoff translation module 62A receives a handoff indication 98 (see FIGS. 7A-7B and 8A-8E for signal flows and descriptions) from the PD BSC 34, and outputs an emulated circuit switched HO Request 104 to the MSC 22. The wireless network handoff translation module 62A additionally receives handoff radio parameters 112 from the MSC 22, and outputs packet-encapsulated handoff radio parameters 114 to the PD BSC 34. The wireless network handoff translation module 62A additionally provides the IMSI, included in the handoff indication 98, to the IMS interface 62B.

The IMS interface 62B generates and outputs a SIP INVITE message 132 to the C-CSCF 44. The SIP INVITE is directed “To” the PSI AS 46, and includes the IMSI in the P-Asserted ID header field. The IMS interface 62B receives a SIP 200 OK message 142 from the C-CSCF 44, indicating that a modified SIP INVITE (from the PSI AS 46 and “To” the AT/MT 66) was accepted by the AS 42 controlling the hybrid AT/MT 66. Upon receipt of the SIP 200 OK, the IMS interface 62B outputs a SIP ACK 150A to the C-CSCF 44, which is propagated to the AS 42.

In response to both the wireless network handoff translation module 62A and the IMS interface 62B, the MGCF 62C generates and outputs MEGACO or H.248 protocol Modify Request signals 100, 146 to the MGw 64, to set up the MGw 64 and activate its dedicated trunk line connection to the MSC 22. The MGCF 62C additionally receives Modify Acknowledge signals 102, 148 from the MGw 64, and reports these signals to the IMS interface 62B and a wireless network handoff translation module 62A.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of facilitating the handoff of a hybrid Access Terminal/Mobile Terminal (AT/MT), engaged in a call with another party, from a packet data wireless network to a circuit switched wireless network, comprising:
receiving a handoff indication from the packet data network;
generating an emulated circuit switched handoff request in response to the handoff indication;
forwarding the emulated circuit switched handoff request to the circuit switched network;
receiving handoff radio parameters from the circuit switched network;
encapsulating the handoff radio parameters into data packets, and forwarding the handoff radio parameters to the packet data network.

2. The method of claim 1 wherein the handoff indication comprises an emulated circuit switched handoff request encapsulated in a packet data structure, and wherein generating an emulated circuit switched handoff request comprises decapsulating the emulated circuit switched handoff request from the handoff indication.

3. The method of claim 1 wherein the emulated circuit switched handoff request is routed to, and the handoff radio parameters are received from, a Mobile Switching Center (MSC) in the circuit switched network.

4. The method of claim 3 further comprising directing a media gateway connected via a dedicated trunk to the MSC to translate media formats between the packet data wireless network and the circuit-switched wireless network.

5. The method of claim 4 wherein the emulated circuit switched handoff request comprises an IS-41 FACDIR2 signal.

6. The method of claim 5 wherein the FACDIR 2 signal includes a CircuitID parameter identifying the dedicated handoff trunk connected to the media gateway.

7. The method of claim 4 further comprising sending signaling messages to a packet switched network operative to establish a media dialog between the handed-off hybrid AT/MT on the circuit switched wireless network and the media gateway.

8. The method of claim 7 wherein the packet switched network is an IP Multimedia Subsystem (IMS) network including a Public Service Identifier Application Server (PSI AS) operative to handle inter-system handoffs and session transfer between IP connectivity points for the AT/MT, and wherein the signaling messages are routed to the PSI AS.

9. The method of claim 8 wherein the signaling messages directed to the PSI AS are further operative to update an existing media dialog with the other party, directing media between the other party and the media gateway.

10. The method of claim 1 wherein the packet data wireless network is a 1xEV-DO network.

11. A Handoff (HO) Function with signaling connections to a packet data wireless network, a circuit switched wireless network, and at least one IP Multimedia Subsystem (IMS) network and operative to facilitate the handoff of a hybrid Access Terminal/Mobile Terminal (AT/MT) from the packet data wireless network to the circuit switched wireless network, comprising:
a wireless network handoff translation module receiving a handoff indication from, and outputting packet-encapsulated handoff radio parameters to, the packet data wireless network, and outputting an emulated circuit switched handoff request to, and receiving handoff radio parameters from, the circuit switched wireless network; and
a IMS interface module exchanging SIP messages with a IMS network; and
a Media Gateway Control Function (MGCF) controlling a Media Gateway (MGw).

12. The HO Function of claim 11 wherein the handoff indication comprises an emulated circuit switched handoff request encapsulated in a packet data structure, and wherein the wireless network handoff translation module is operative to decapsulate the emulated circuit switched handoff request and forward it to the circuit switched wireless network.

13. The HO Function of claim 11 wherein the wireless network handoff translation module is operative to generate and output an emulated circuit switched handoff request in response to the handoff indication.

14. The HO Function of claim 11 wherein the IMS interface module receives a unique identifier of the AT/MT from the wireless network handoff translation module.

15. The HO Function of claim 14 wherein the IMS interface module generates a SIP INVITE message to a handoff server in the IMS network, indicating the hybrid AT/MT as the calling party.

16. The HO Function of claim 15 wherein the SIP INVITE message includes the unique identifier of the AT/MT in the P-Asserted ID header field.

17. The HO Function of claim 16 wherein the unique identifier of the AT/MT is an International Mobile Subscriber Identity (IMSI).

18. A translation network operative to facilitate handoff of a hybrid Access Terminal/Mobile Terminal (AT/MT) from a packet data wireless network to a circuit switched wireless network during a call with another party, comprising:
a Media Gateway (MGw) connected to the circuit switched wireless network via a dedicated handoff trunk and connected to one or more packet data networks by a packet data link, the MGw operative to translate media between packet data and circuit switched formats; and
a Handoff (HO) Function controlling the MGw, the HO Function having signaling connections to the packet data wireless network, the circuit switched wireless network, and at least one IP Multimedia Subsystem (IMS) network.

19. The translation network of claim 18 wherein the HO Function is operative to receive a handoff indication from the packet data wireless network;
generate an emulated circuit switched handoff request and output the emulated circuit switched handoff request to the circuit switched wireless network;
receive handoff radio parameters from the circuit switched a wireless network;
and
encapsulate and output the handoff radio parameters to the packet data wireless network.

20. The translation network of claim 19 wherein the handoff indication comprises a packet-encapsulated emulated circuit switched handoff request, and wherein the HO Function is operative to decapsulate the emulated circuit switched handoff request and output it to the circuit switched wireless network.

21. The translation network of claim 19 wherein the HO Function is operative to generate the emulated circuit switched handoff request in response to the handoff indication.

22. The translation network of claim 18 wherein the HO Function exchanges SIP messages with at least one IP Multimedia Subsystem (IMS) network so as to establish a media path between the hybrid AT/MT and the MGw following the handoff of the hybrid AT/MT from the packet data wireless network to the circuit switched wireless network.

23. The translation network of claim 22 wherein the IMS network includes a Public Service Identifier Application Server (PSI AS) operative to handle inter-system handoffs and session transfer between IP connectivity points for the AT/MT, and wherein the HO Function directs SIP messages to the PSI AS.

24. The translation network of claim 23 wherein the PSI AS is operative to establish the IMS network media path between the hybrid AT/MT and the MGw following the handoff of the hybrid AT/MT from the packet data wireless network to the circuit switched wireless network.

25. The translation network of claim 24 wherein the PSI AS is further operative update an existing media dialog with the other party, directing media between the other party and the MGw.

26. A method of facilitating the handoff of a hybrid Access Terminal/Mobile Terminal (AT/MT) from a packet data wireless network to a circuit switched wireless network by an Application Server (AS) having a sip:uri Public Service Identifier (PSI) in an IP Multimedia Subsystem (IMS) network, the PSI AS operative to handle inter-system handoffs and session transfer between IP connectivity points for a specific terminal, comprising:
receiving a SIP INVITE message directed to the PSI AS and indicating the hybrid AT/MT as the calling party;
performing an ENUM conversion on the hybrid AT/MT indicator to generate a SIP URI for the hybrid AT/MT;
swapping the called and calling party identifiers to generate a modified SIP INVITE message; and
sending the modified SIP INVITE message to a Serving-Call Session Control Function (C-CSCF) in the IMS network.

27. The method of claim 26 wherein the hybrid AT/MT indicator is an International Mobile Subscriber Identity (IMSI).

28. The method of claim 26 wherein the hybrid AT/MT identifier is in the P-Asserted ID header field of the received SIP INVITE message, and wherein the sip:uri of the PSI AS is in the P-Asserted ID header field of the modified SIP INVITE message.
